(19) United States
(12) Patent Application Publication
(10) Pub. No.: US 2017/0065988 A1
(43) Pub. Date: Mar. 9, 2017

(54) SHOWER HEAD CAPABLE OF DISPLAYING DIFFERENT COLORS ACCORDING TO WATER TEMPERATURE

(71) Applicant: So-Mei HUANG, TAI PING CITY (TW)

(72) Inventor: So-Mei HUANG, TAI PING CITY (TW)

(21) Appl. No.: 14/848,224

(22) Filed: Sep. 8, 2015

(51) Int. Cl. B05B 1/18; G01K 1/02; G01K 13/02

(52) U.S. Cl. CPC B05B 1/18; G01K 13/02; G01K 1/02

(57) ABSTRACT

The invention relates to a shower head capable of displaying different colors according to the water temperature, which includes a water outlet disc disposed at the front side of the main body of the shower head. The surface of the water outlet disc includes at least one temperature displaying area, and the temperature displaying disc includes a plurality of holes connected to the at least one of the water outlet channel of the main body. The temperature displaying area consists of different thermochromism materials. By means of the thermochromism materials capable of displaying different colors according to the water temperature, the user can immediately know the current water temperature to avoid burn injury.

### BACKGROUND OF THE INVENTION

a) Field of the Invention The invention relates to a shower head capable of displaying different colors according to the water temperature. By means of the color change of the temperature displaying area installed on the surface of the water outlet disc of the shower head, the thermochromism materials of the temperature displaying area can show different colors according to the water temperature so as to warn the user of the current water temperature and avoid burn injury.

b) Description of the Prior Art

Since conventional shower heads used in bathrooms cannot show the water temperature, so users should feel the water temperature by their skin and then adjust the water temperature accordingly. However, which may have potential danger; if the water temperature is too high, the user cannot immediately feel the water temperature but needs some time; in other words, the user cannot know it is necessary to adjust the water temperature before feeling the pain due to burn. Besides, the user should use the skin of his hands to feel the water temperature, so his hands may be burned again due to improper operation. Accordingly, a shower head capable of using lamp-lights to displaying the water temperature is developed for the purpose of solving the above problem. The relevant technology is disclosed by U.S. Pat. No. 7,607,789B2, U.S. Pat. No. 8,911,100B2 and the like. This technology mainly uses the temperature sensing component of a lighting circuit control module to detect the water temperature, and then uses the lighting circuit control module to control the lamp-lights with different colors to show the temperature; in this way, the user can know the current temperature to prevent form burn injury.

The above technology uses the color change of the lamp-lights t to show the temperature range of the water temperature, which can effectively solve the shortcoming of the aforementioned conventional shower head. However, the technology also has some problems; more specifically, the power of the lighting circuit control module should be supplied by a micro battery; thus, if the power of the battery is running low, the disassembly and installation of the battery will be a trouble. Accordingly, another shower head is developed for solving the above problem, which uses the power of the water flow to drive a water wheel to rotate so as to generate power to supply the shower head. The shower head is more convenient because the disassembly and installation of the battery can be avoided, but the cost of the shower head is very high.

### SUMMARY OF THE INVENTION

In view of this, the inventor finally completes the shower head capable of displaying different colors according to the water temperature of the present invention after numerous improvements, namely, the object of the present invention is to provide a shower head capable of displaying different colors according to the water temperature; by means of the color change of the temperature displaying area installed on the surface of the water outlet disc of the shower head, the thermochromism materials of the temperature displaying area can show different colors according to the water temperature so as to warn the user of the current water temperature and avoid burn injury.

To achieve the above object according to the invention, the shower head capable of displaying different colors according to the water temperature of the present invention, which at least includes a main body and a water outlet disc, wherein:

The main body, which includes a water outlet channel.

The water outlet disc, which is disposed at the front side of the main body, wherein the surface of the water outlet disc includes at least one temperature displaying area, and the temperature displaying area includes a plurality of holes; each of the holes is connected to at least one water outlet channel; the temperature displaying area consists of different thermochromism materials capable of displaying different colors according to the temperature range of the water temperature.

The above temperature displaying area is distributed over the whole or a portion of the surface of the water outlet disc.

The above main body further includes a lighting circuit control module.

According to another embodiment of the present invention, the shower head capable of displaying different colors according to the water temperature of the present invention at least includes a main body and a water outlet disc, wherein:

The main body, which includes a water outlet channel.

The water outlet disc, which is disposed at the front side of the main body, the water outlet disc includes a cover and an inner disc; the inner disc abuts against the inner side of the cover, the inner disc is a soft disc with a plurality of water outlet columns, and each of the water outlet columns includes a water hole, the surface of the water outlet disc includes at least one temperature displaying area, and the temperature displaying area includes a plurality of holes, the holes are corresponding to the water outlet columns, and penetrate through and protrude from the surface of the water outlet disc, the water holes are connected to the at least one water outlet channel of the main body, the temperature displaying area consists of different thermochromism materials capable of displaying different colors according to the temperature range of the water temperature.

The above temperature displaying area is distributed over the whole or a portion of the surface of the water outlet disc.

The above main body further includes a lighting circuit control module.

Each of above water outlet columns consists of different thermochromism materials capable of displaying different colors according to the temperature range of the water temperature.

### BRIEF DESCRIPTION OF THE DRAWINGS

FIG. 1 is a three-dimensional exploded view according to the present invention;

FIG. 2 is a combination cross-sectional view according to the present invention;

FIG. 3 is a schematic diagram (1) of the temperature displaying area of the water outlet disc according to the present invention;

FIG. 4 is a schematic diagram (2) of the temperature displaying area of the water outlet disc according to the present invention;

FIG. 5 is a schematic diagram of an embodiment of the present invention with a lighting circuit control module;

FIG. 6 is a three-dimensional exploded view according to another embodiment of the present invention;

FIG. 7 is a combination cross-sectional view according to another embodiment of the present invention;

FIG. 8 is a schematic diagram (1) of the temperature displaying area of the water outlet disc according to another embodiment of the present invention;

FIG. 9 is a schematic diagram (2) of the temperature displaying area of the water outlet disc according to another embodiment of the present invention; and

FIG. 10 is a schematic diagram of another embodiment of the present invention with a lighting circuit control module.

### DETAILED DESCRIPTION OF THE INVENTION

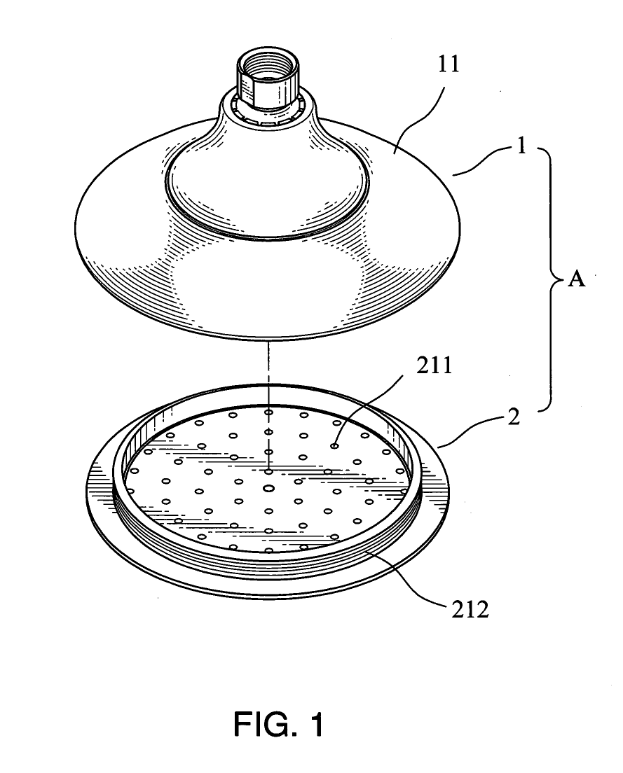

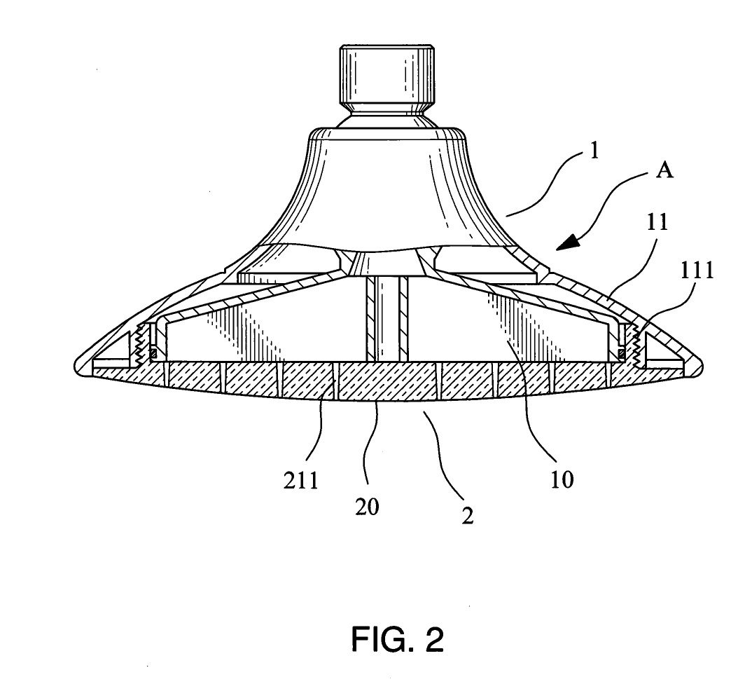

Please refer to FIG. 1˜FIG. 4, the shower head capable of displaying different colors according to the water temperature of the present invention, which at least includes a main body 1 and a water outlet disc 2, wherein:

The main body 1, which includes a water outlet channel 10.

The water outlet disc 2, which is disposed at the front side of the main body 1, wherein the surface 20 of the water outlet disc 2 includes at least one temperature displaying area 20A, 20B, and the temperature displaying area 20A, 20B includes a plurality of holes 211; each of the holes 211 is connected to at least one water outlet channel 10 of the main body 1; the temperature displaying area 20A, 20B consists of different thermochromism materials capable of displaying different colors according to the temperature range of the water temperature for the purpose of warning the user of the current water temperature and avoid burn injury.

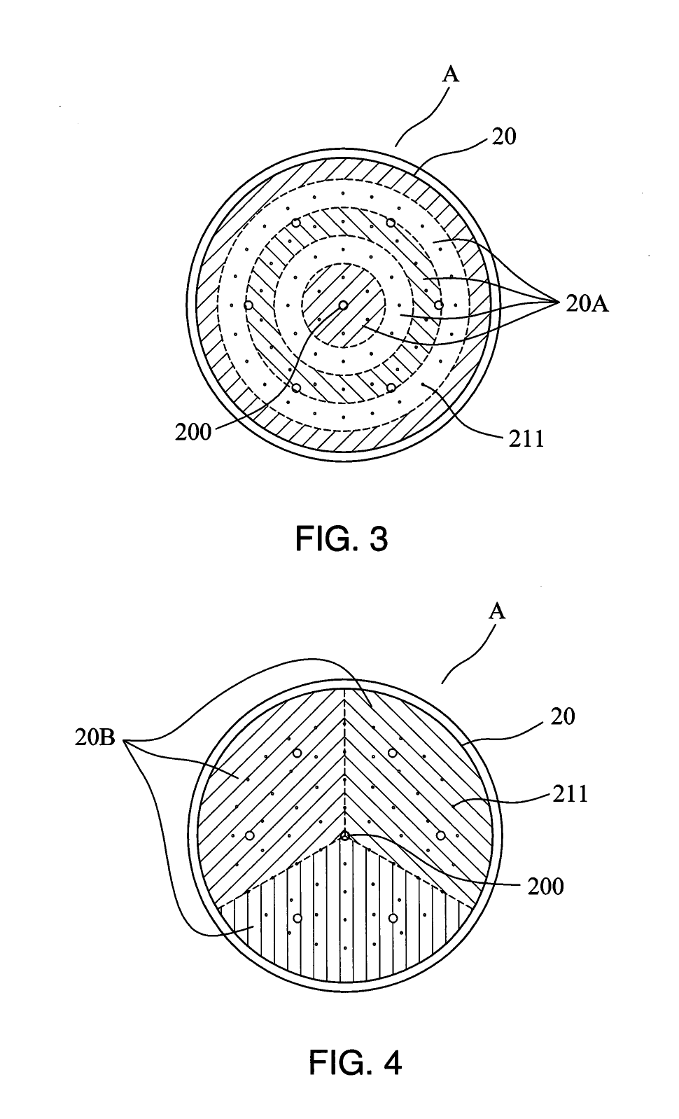

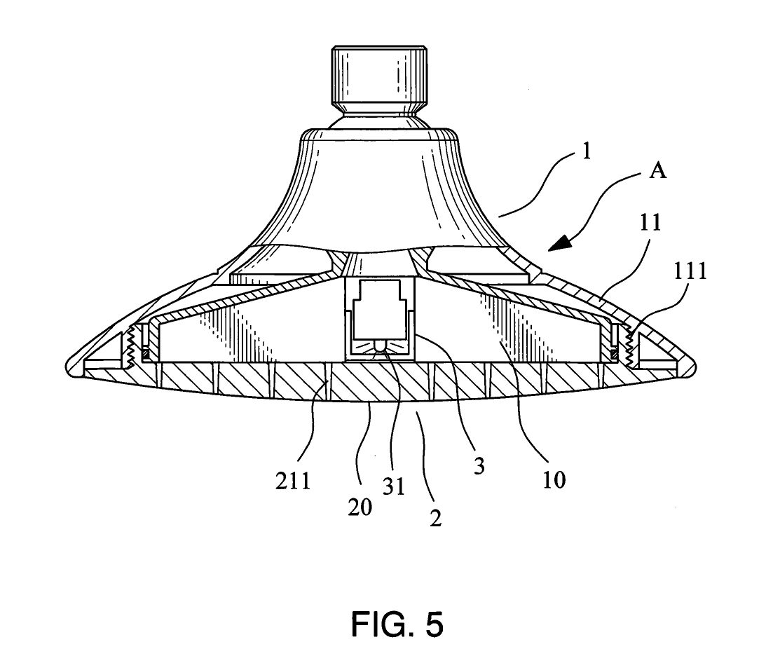

The distribution of the above temperature displaying area 20A, 20B over the surface 20 can be adjusted according to the actual requirements, wherein the temperature displaying area 20A, 20B may be distributed over the whole of the surface 20 or a portion of the surface. Alternatively, the temperature displaying 20A may consist of multiple rings, which may take the center 200 of the surface 20 to radially distribute over the surface 20 (as shown in FIG. 3); or temperature displaying area 20B may consist of several parts with the same area, which may take the center 200 of the surface 20 to distribute over the surface 20 (as shown in FIG. 4). Moreover, the temperature displaying area 20A, 20B may be made of different thermochromism materials to preset them to display different colors under different temperature ranges according to the requirements. For example, under normal temperature, the temperature displaying area 20A, 20B will display the first kind of color setting; when the water temperature reaches the color change condition of the temperature displaying area 20A, 20B, temperature displaying area 20A, 20B will display the second kind of color setting; until the water temperature reduces to the normal temperature, the temperature displaying area 20A, 20B will return to the first kind of color setting. In this way, the temperature displaying area 20A, 20B with different temperature range sensitivity distributed over the surface 20 can warn the user of the current water temperature by one or more than one colors so as to prevent from burn injury.

The main body 1 according to the present invention further includes a lighting circuit control module 3. The lighting circuit control module is a prior art; however, after the lighting circuit control module 3 is combined with the present invention, the lighting circuit control module 3 only needs one lamp (e.g. LED lamp) to provide light source to show the color changes of the temperature displaying area 20A, 20B to the external of the shower head A. Furthermore, the lamp 31 only needs to provide one light source with single color to display different color changes; thus, it is not necessary to use a light source with different colors or use multiple lamps with different colors, which can significantly reduce the cost of the lighting circuit control module 3 and its application can be more comprehensive.

The above water outlet disc 2 according to the present invention includes a first combination portion 212 (it may be an outer screw thread, an inner screw thread or a lock hole). The first combination portion 212 engages with a second combination portion 111 of the main body 1 (it may be an outer screw thread, an inner screw thread or a lock hole) so as to firmly fix the water outlet disc 2 on the main body 1.

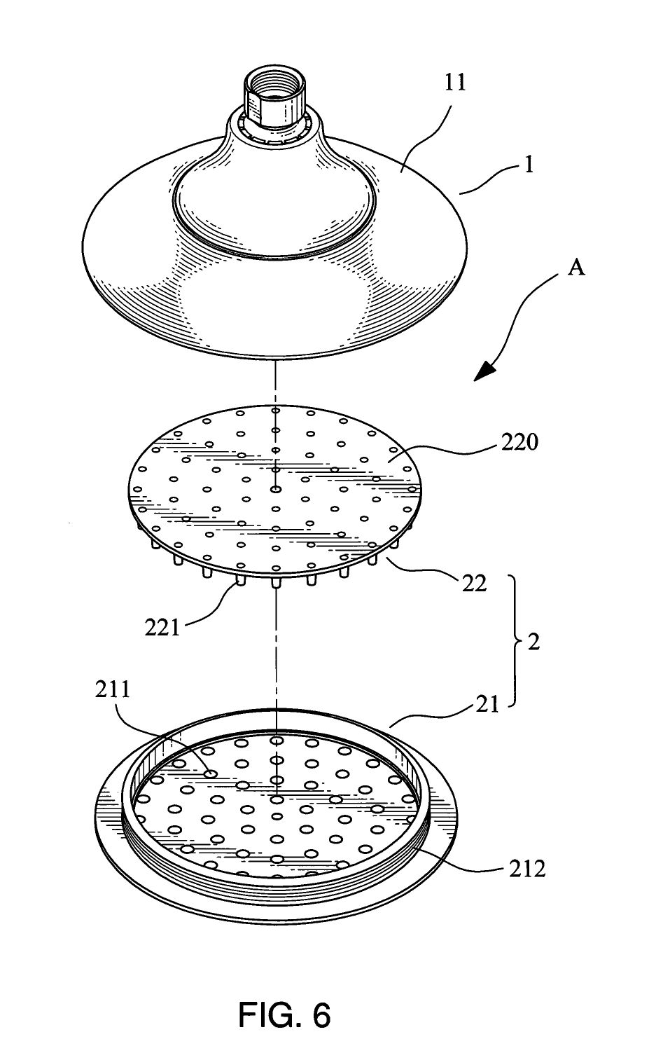

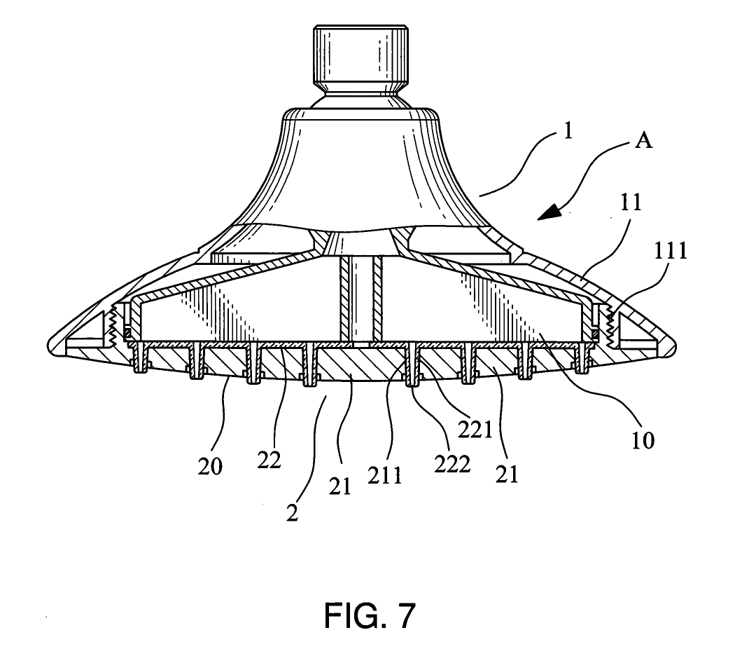

Please refer to FIG. 6˜FIG. 9, which illustrate another embodiment of the present invention; the shower head A at least includes a main body 1 and a water outlet disc 2, wherein:

The main body 1, which includes a water outlet channel 10.

The water outlet disc 2, which is disposed at the front side of the main body 1, the water outlet disc 2 includes a cover 21 and an inner disc 22; the inner disc 22 abuts against the inner side of the cover 21, the inner disc 22 is a soft disc with a plurality of water outlet columns 221, and each of the water outlet columns 221 includes a water hole 222, the surface 20 of the water outlet disc 2 includes at least one temperature displaying area 20A, 20B, and the temperature displaying area 20A, 20B includes a plurality of holes 211, the holes 211 are corresponding to the water outlet columns 221, and penetrate through and protrude from the surface 20, the water holes 222 are connected to the at least one water outlet channel 10 of the main body 1, the temperature displaying area 20A, 20B consists of different thermochromism materials capable of displaying different colors according to the temperature range of the water temperature for the purpose of warning the user of the current water temperature and avoid the burn injury.

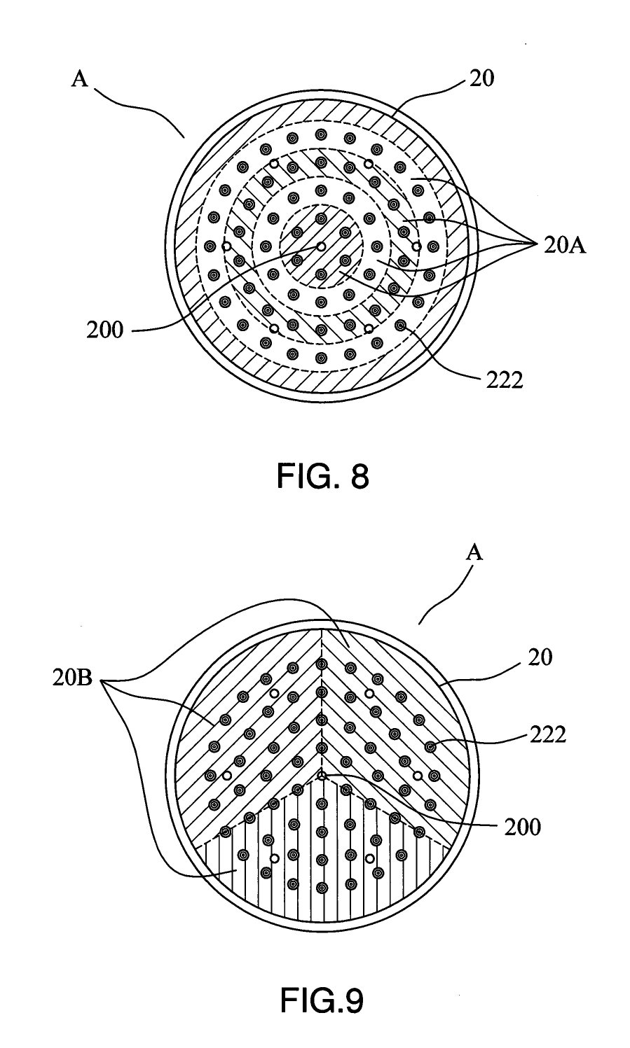

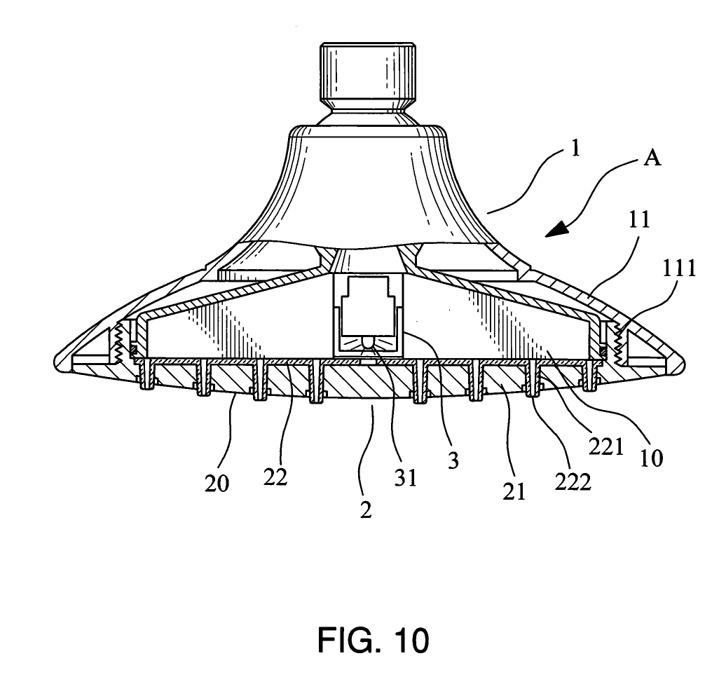

The distribution of the above temperature displaying area 20A, 20B over the surface 20 can be adjusted according to the actual requirements, wherein the temperature displaying area 20A, 20B may be distributed over the whole of the surface 20 or a portion of the surface. Alternatively, the temperature displaying 20A may consist of multiple rings, which may take the center 200 of the surface 20 to radially distribute over the surface 20 (as shown in FIG. 8); or temperature displaying area 20B may consist of several parts with the same area, which may take the center 200 of the surface 20 to distribute over the surface 20 (as shown in FIG. 9). Moreover, the temperature displaying area 20A, 20B may be made of different thermochromism materials to preset them to display different colors under different temperature ranges according to the requirements. For example, under normal temperature, the temperature displaying area 20A, 20B will display the first kind of color setting; when the water temperature reaches the color change condition of the temperature displaying area 20A, 20B, temperature displaying area 20A, 20B will display the second kind of color setting; until the water temperature reduces to the normal temperature, the temperature displaying area 20A, 20B will return to the first kind of color setting. In this way, the temperature displaying area 20A, 20B with different temperature range sensitivity distributed over the surface 20 can warn the user of the current water temperature by one or more than one colors so as to prevent from burn injury.

The above water outlet columns 221 consist of different thermochromism materials, which can show different colors in the temperature displaying area 20A, 20B according to different temperature ranges of the water temperature.

The main body 1 according to the present invention further includes a lighting circuit control module 3. The lighting circuit control module is a prior art; however, after the lighting circuit control module 3 is combined with the present invention, the lighting circuit control module 3 only needs one lamp (e.g. LED lamp) to provide light source to show the color changes of the temperature displaying area 20A, 20B to the external of the shower head A. Furthermore, the lamp 31 only needs to provide one light source with single color to display different color changes; thus, it is not necessary to use a light source with different colors or use multiple lamps with different colors, which can significantly reduce the cost of the lighting circuit control module 3 and its application can be more comprehensive.

The above water outlet disc 2 according to the present invention includes a first combination portion 212 (it may be an outer screw thread, an inner screw thread or a lock hole). The first combination portion 212 engages with a second combination portion 111 of the main body 1 (it may be an outer screw thread, an inner screw thread or a lock hole) so as to firmly fix the water outlet disc 2 on the main body 1.

What is claimed is:

1. A shower head capable of displaying different colors according to a water temperature, which includes a main body and a water outlet disc comprising:
the main body, which includes a water outlet channel;
the water outlet disc, which is disposed at a front side of the main body, wherein a surface of the water outlet disc includes at least one temperature displaying area, and the temperature displaying area includes a plurality of holes; each of the holes is connected to at least one water outlet channel; the temperature displaying area consists of different thermochromism materials capable of displaying different colors according to a temperature range of the water temperature.

2. The shower head capable of displaying different colors according to the water temperature as stated in claim 1, wherein the temperature displaying area is distributed over a whole of the surface of the water outlet disc.

3. The shower head capable of displaying different colors according to the water temperature as stated in claim 1, wherein the temperature displaying area is distributed over a portion of the surface of the water outlet disc.

4. The shower head capable of displaying different colors according to the water temperature as stated in claim 1, wherein the main body further includes a lighting circuit control module.

5. A shower head capable of displaying different colors according to a water temperature, which includes a main body and a water outlet disc comprising:
the main body, which includes a water outlet channel;
the water outlet disc, which is disposed at a front side of the main body, the water outlet disc includes a cover and an inner disc; the inner disc abuts against an inner side of the cover, the inner disc is a soft disc with a plurality of water outlet columns, and each of the water outlet columns includes a water hole, a surface of the water outlet disc includes at least one temperature displaying area, and the temperature displaying area includes a plurality of holes, the holes are corresponding to the water outlet columns, and penetrate through and protrude from the surface of the water outlet disc, the water holes are connected to the at least one water outlet channel of the main body, the temperature displaying area consists of different thermochromism materials capable of displaying different colors according to a temperature range of the water temperature.

6. The shower head capable of displaying different colors according to the water temperature as stated in claim 5, wherein the temperature displaying area is distributed over a whole of the surface of the water outlet disc.

7. The shower head capable of displaying different colors according to the water temperature as stated in claim 5, wherein the temperature displaying area is distributed over a portion of the surface of the water outlet disc.

8. The shower head capable of displaying different colors according to the water temperature as stated in claim 5, wherein the main body further includes a lighting circuit control module.

9. The shower head capable of displaying different colors according to the water temperature as stated in claim 5, wherein each of water outlet columns consists of different thermochromism materials capable of displaying different colors according to the temperature range of the water temperature.
